(19) United States
(12) Patent Application Publication
(10) Pub. No.: US 2023/0420151 A1
(43) Pub. Date: Dec. 28, 2023

(54) PHOSPHATE BASED TARGETS

(71) Applicant: UNIVERSITETET I OSLO, Oslo (NO)

(72) Inventors: Bent Wilhelm SCHOULTZ, Ås (NO); Gjermund HENRIKSEN, Mjøndalen (NO)

(21) Appl. No.: 18/033,911

(22) PCT Filed: Oct. 29, 2021
(86) PCT No.: PCT/EP2021/080166

§ 371 Date: Apr. 26, 2023

(30) Foreign Application Priority Data
Oct. 30, 2020 (GB) 2017229.2

(51) Int. Cl. G21G 1/00; C03C 4/00; C03C 3/16

(52) U.S. Cl. CPC G21G 1/00; C03C 4/0042; C03C 3/16; G21G 2001/0036; G21G 2001/0094

(57) ABSTRACT

The invention relates to a phosphate based glass target material, wherein said material comprises an isotopically enriched element or monoisotopic element.

This invention concerns phosphate based glass target materials, in particular those comprising an isotopically enriched element or monoisotopic element. The invention also relates to a process for producing radionuclides comprising irradiating such phosphate based glass targets with a high energy particle beam. The process is particularly suitable to applications wherein the beam is provided by a cyclotron. The invention also relates to the use of phosphate based glass targets in the production of radionuclides.

### BACKGROUND

The global use of nuclear medicine, valued to 9.6 billion USD in 2016, accounts for more than 40 million procedures annually. With a prospected annual increase of 5%, the global radioisotope market is expected to reach 17 billion USD by 2021. Medical radioisotopes account for 80% of the global market of radioisotopes. They can be employed as therapeutic or imaging agents for radiation therapy as part of biologically relevant molecules, such as small molecular weight organic compounds, peptides, proteins and antibodies.

Positron Emission Tomography (PET) technology has the ability to provide functional and quantitative imaging. PET is a non-invasive medical imaging technology which is useful for generating high-resolution images which can be used in diagnostic applications in the fields of oncology, neurology and cardiology, for example. Single-photon emission computed tomography (SPECT) is another important imaging technique, used mainly in the field of nuclear cardiology using ^{99m}Tc. The relative ease of production of this radionuclide (from ⁹⁹Mo), together with its relatively low cost, have resulted in the employment of this technology in around 80% of all nuclear medicine procedures. In other applications, such as whole body imaging, there is a preference to use depth-independent quantitative imaging obtained by PET.

Supplies of ⁹⁹Mo for ^{99m}Tc generators are predicted to drop significantly in the coming years, due to decommissioning of nuclear reactor production plants. Together with ^{99m}Tc's limited versatility, this has prompted considerable technological development of the supply chain of PET radiopharmaceuticals, including more efficient cyclotrons to improve availability of PET isotopes. As a result, more cost effective PET radiopharmaceuticals are emerging, leading to an increase in PET facilities worldwide, in particular those with cyclotrons for in-house production of radionuclides.

The recent cyclotron portfolio of major vendors has the potential for substantially increased yield of established and new radionuclides, especially from proton-, deuteron- or alpha-particle mediated nuclear reactions. To fully exploit the production capacity of these high power cyclotrons, however, the development of mechanically and thermostable targets for the nuclear reaction in question is a requirement. One limitation of current targets is the intensity of accelerated particle flux that can be applied.

The most commonly used PET radionuclide is ¹⁸F (t½=109.7 m) for the production of [¹⁸F]fluorodeoxy glucose (FDG), the radiopharmaceutical used in approximately 80% of all PET investigations. ¹⁸F is currently produced from a low efficacy liquid target. A solid target for ¹⁸F, with increased concentration of ¹⁸O (from which the ¹⁸F is produced by reaction with incident protons) would represent a major step in providing this radionuclide at a lower cost and with increased availability.

Most of the currently employed targets for metallic radionuclides are in the metallic form of the chemical element in question. Moreover, the target assembly (target material plus holder) are constituted of a chemical bond between the target and its backing material (metal targets) or of a dilute solution of a salt of the target isotope (liquid target).

The upper limit for the flux of particles, and thereby the yield of the desired radionuclide product, depends fundamentally on the physical properties of the target material such as heat capacity, rate of heat transfer and melting or boiling point of the material, as well as the cooling properties provided by the target material holder. Irradiation of a target material with e.g. protons from a high-power cyclotron will deposit a major quantity of energy within the target, which makes cooling with a liquid e.g. water, or a cooling gas e.g. helium, or a combination thereof required.

The limitations with established technology for targetry are being compensated by using substantially less than maximum particle beam current for a more extended time interval. This leads to an undesirable, highly pressurized time schedule for radionuclide production centers. Thus, at present, the low production capacity for radionuclides can only be solved by constructing and operating more cyclotrons

In order to fully exploit the possibility of high beam currents from present and upcoming cyclotron operational parameters, there is a call for improving target technology.

Previous strategies have employed ceramic target materials, for example as described in WO 2020/048980. However, testing involving irradiating the ceramic target materials in a proton-current ramp up study revealed that deposition of higher energy caused weakening of the material. This weakening of the internal structure led to visual deformation of the material. Such deformation upon exposure to relatively high energy deposition encountered with production-relevant proton currents is clearly undesirable. There thus remains a need to provide alternative target materials which avoid such issues.

The present inventors have surprisingly found that phosphate based glass target materials offer an attractive solution. In particular the phosphate based glass materials expand upon heating, (e.g. during irradiation with a high energy particle beam), the opposite behavior to that of crystalline ceramic materials. A phosphate based glass target material remains in place and effectively captures the particle beam from the accelerator, and in addition has phase-transfer properties that allows for exposure to production relevant energy deposition from particle beams.

### SUMMARY OF INVENTION

Thus, viewed from a first aspect the invention provides a phosphate based glass target material, wherein said material comprises an isotopically enriched element or monoisotopic element.

Viewed from a further aspect, the invention provides a process for preparing phosphate based glass materials as hereinbefore defined, said process comprising
i. mixing a metal, metalloid or non-metal oxide with dilute phosphorous acid (H₃PO₄) to form a phosphate compound.
ii. melting said phosphate compound with phosphorous pentoxide and/or or an oxide of the isotope enriched element to produce the phosphate based glass material.

Viewed from another aspect the invention provides a process for the production of a radionuclide, comprising irradiating a phosphate based glass target with a high energy particle beam.

In a particular aspect, the invention provides a process for the production of a radionuclide as hereinbefore defined, comprising the steps:
providing a plate having a recessed portion,
placing said target in the recessed portion;
covering the target with a foil such that the target is encapsulated by the foil and the surface of the recessed portion,
securing the foil to the plate such that the target is fixed relative to the plate;
wherein the foil has a higher melting point than the target glass transition temperature; and
irradiating the encapsulated target with a beam of high energy particles.

In another aspect, the invention provides the use of a phosphate based glass target in a process for producing radionuclides.

Viewed from a further aspect, the invention provides the use of phosphate based glass materials as a target in a process for producing radionuclides.

### Definitions

The term “target” and “target material” are used interchangeably herein to refer to the material which is irradiated with a high energy particle beam to produce radionuclide(s). It will be understood that by describing the phosphate based glass materials of the invention as “target materials”, it is implied that they possess properties rendering them suitable for this application.

The term “glass” defines a large class of materials with highly variable mechanical and optical properties that lead to solidification from a molten state without crystallization. They are typically made by silicates upon fusion with boric oxide, aluminum oxide, or phosphorus pentoxide, they are generally hard, brittle, and can be transparent or translucent. They may be considered to be super-cooled liquids rather than true solids. In the context of the present invention, the term “glass” should be distinguished from “ceramic”. Ceramic materials typically contain a mixture of ionic and covalent bonds between atoms. The resulting material may be crystalline, semi-crystalline, or vitreous. Conversely, glass materials are amorphous.

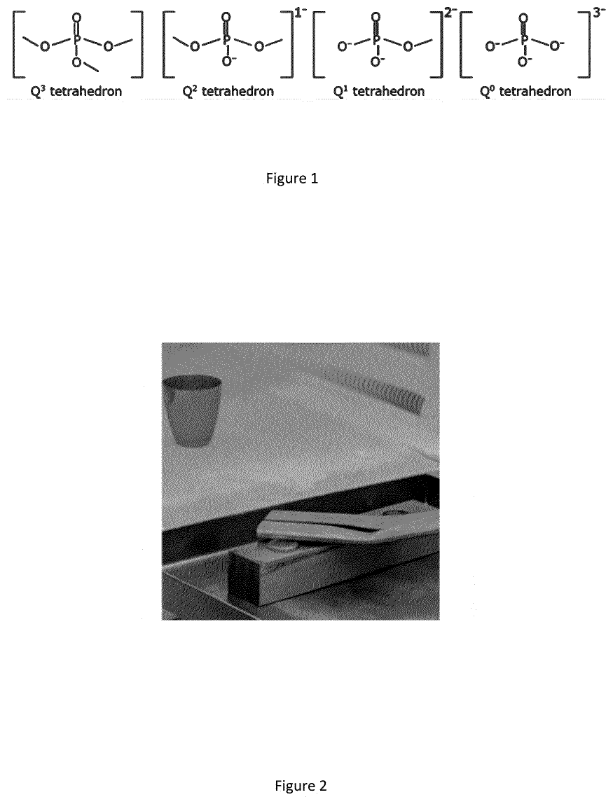

“Phosphate based glasses” comprise a random three-dimensional network of glass. This network is made up of tetrahedral phosphate anions with varying numbers of bridging oxygen ions (see FIG. 1). The main constituent forming a network, thus being essential for structure and physiochemical properties of the glass, is phosphorous pentoxide (P₂O₅), consisting of tetrahedral phosphate anions. A given phosphate tetrahedron functions both to bind a bridging oxygen to the phosphorus atom, combined with forming (P—O—P) bonds, that is the link to adjacent tetrahedra, producing the glass structure.

A metal ion (M) can form a (P—O-M) bond, thus becoming an integral part of the phosphate based glass. The applicability of these structures for the production of radionuclides stems from the phosphate based glasses' ability to coordinate one metal out of a set of target metal ions.

### DETAILED DESCRIPTION OF INVENTION

The present invention relates to a process for the production of radionuclides, comprising irradiating a phosphate based glass target with a high energy particle beam. The invention further relates to phosphate based glass targets themselves, wherein said targets comprise an isotopically enriched element or monoisotopic element.

### Phosphate Based Glass Target Material

The phosphate based glass target may comprise any suitable inorganic material which contains phosphorus and oxygen together with a metal, metalloid or non-metal element, or mixtures thereof.

The phosphate-based glass target may comprise all elements in their natural isotopic composition or it may comprises an isotopically enriched element or monoisotopic element. The skilled person will appreciate that suitable isotopes may be chosen depending on the required radionuclide product.

In the particular aspect of the invention relating to the phosphate based glass target materials themselves, these materials always comprise an isotopically enriched element or monoisotopic element.

It is within the ambit of the invention for the target material to comprise more than one (e.g. two) isotopically enriched elements or monoisotopic elements, however it is preferable if only a single isotopically enriched element or monoisotopic element is present. In one embodiment, for example, additional isotopically enriched elements or monoisotopic elements may be added. This may lead to a change in physical properties of the target, such as an increase in the glass transition temperature. It will also be appreciated that the phosphate based glass target may further comprise other elements which may influence the physical properties of the target.

The isotopically enriched element or monoisotopic element may be selected from any suitable metal, metalloid or non-metal element.

In one preferred aspect, the isotopically enriched element or monoisotopic element is selected from the group consisting of Mo, Ra, Y, Rb, Ca, Ni, Zn, Ga, O, Se, Te, Bi, Th and Yb, preferably Mo, Y and Zn. Particularly preferred isotopically enriched elements or monoisotopic elements are Mo and Zn.

In a particularly preferred embodiment, the isotope is selected from the group consisting of ¹⁰⁰Mo, ²²⁶Ra, ⁸⁹Y, ⁸⁵Rb, ⁴⁴Ca, ⁶⁴Ni, ⁷⁰Zn, ⁶⁷Zn, ⁶⁸Zn, ⁶⁹Ga, ¹⁸O, ⁷⁶Se, ⁷⁷Se, ¹²⁴Te, ²⁰⁹Bi and ¹⁷⁶Yb, preferably ¹⁰⁰Mo and ⁶⁸Zn.

The phosphate-based glass target materials of the invention typically have a glass transition temperature (Tg) in the range 200 to 2000° C. In particular, where the target glass material comprises Zn, the glass transition temperature of the material may be in the range 800° C. to 1000° C.

The density of the phosphate-based glass target material may be 2 to 10 g/cm³, such as 2.5 to 5 g/cm³.

As previously discussed, the phosphate based glass target material contains a metal, metalloid or non-metal element, or mixtures thereof. An aim of the invention is to maximize the content of these metal, metalloid or non-metal elements in the material. Preferably, the amount of these elements in the material is in the range 10 to 50 wt %, more preferably 25 to 40 wt % relative to the total weight of the material as a whole. In particular, where the metal, metalloid or non-metal element is zinc, the amount of zinc in the target material is preferably in the range 20 to 40 wt %, such as 30 to 40 wt %, relative to the total weight of the material as a whole.

The phosphate based glass target material may be prepared by any suitable method known in the art. The phosphorous or phosphate functional group may be introduced to the materials in many forms. Different forms, such as single or cross bonding phosphorous groups, (FIG. 1) coordinate the target atoms into different forms of the resulting target material in the range of crystalline to amorphous glassy forms of phosphate. The combinations of different phosphorous species with glass forming modifiers governs the desired phosphate-based glass material.

Example methods include reacting a metal with phosphorous species to prepare a phosphate based material containing a metal.

In one embodiment, the material is produced by mixing an appropriate metal, metalloid or non-metal oxide with dilute phosphoric acid (H₃PO₄) to produce a hydrated ceramic phosphate intermediate material. The crystal water is removed from the salt, typically by heating the intermediate material. The constitution of the phosphate ceramic can be further altered by continuing heat treatment to achieve sintered, fused or glassy structure by adding phosphor pentoxide and/or glass modifiers.

The present invention thus covers, in an embodiment, a process for preparing a phosphate based glass material as defined herein, said process comprising

i. mixing a metal, metalloid or non-metal oxide with dilute phosphorous acid (H₃PO₄) to form a phosphate compound.

ii. melting said phosphate compound with phosphorous pentoxide and/or or an oxide of the isotope enriched element to produce the phosphate based glass material.

Alternatively, the phosphate based glass material may be produced by other methods e.g. reacting the target element with a phosphate specie, e.g. dehydrated phosphoric acid, phosphor pentoxide, and by heating the material to obtain a melt.

The methods of the invention used to prepare the phosphate-based target materials typically do not comprise the addition of frequently used glass modifiers such as sodium, calcium and magnesium oxides. These elements are, in other preparations, added for adjusting the stability of phosphate glasses. However, in the context of the present invention they can lead to the formation of unwanted radioactive or stable side products during irradiation.

The physiochemical properties of the phosphate based glass material can be changed by altering such properties as density, heat transfer capacity, melting point or glass transition temperature, and solubility. This is achieved by applying different stoichiometric amounts of the different phosphate units, the target element and/or adding non-target elements together with heat treatment. Upon adding glass forming constituents, e.g. metal oxides of the enriched element, the phosphate based material yields glass properties.

The phosphate based glass materials described herein are, in general, soluble in solvents based on acids and bases, a crucial step in preparation for subsequent chromatographic methods intended for isolating radionuclide products.

In embodiments where an isotopically enriched target material is desired, this is usually obtained by employing a suitably enriched metal, metalloid or non-metal oxide reagent, although it is also possible for isotopically enriched phosphoric acid to be employed (e.g. where the isotope is ¹⁸O)

The target material can be prepared in different shapes. In general, the target surface area should be larger than the extension of the particle beam intercept in order to utilize a maximum of incoming particles. Thus, it will be appreciated that the shape and dimensions of a suitable target material will differ accordingly, as a function of beam spread and the dimension and constitution of the target holder in question. In one aspect, the target material is prepared as a disc for use in the processes of the invention. In one preferable embodiment, the target is in the form of a disc with a diameter of 17 mm.

Preferably, the thickness of the disc is within a range so as to provide a “thick target yield”. By “thick target yield” we mean the thickness of the target which gives the maximum yield of the nuclear reaction in question from a given particle charge and its energy. It will be appreciated that this thickness will vary for different nuclear reactions, beam energies and different target densities.

The present inventors have surprisingly found that the phosphate based glass target materials can withstand phase transfer caused by high-energy depositions. It naturally follows that the more heat the target can withstand, the greater beam intensity can be used with higher production yields as a result.

### Process

The process of the invention may be any suitable process known in the art for the production of radionuclides, comprising irradiating a phosphate based glass target with a high energy particle beam. The skilled person will be familiar with such processes and the instruments employed therein.

The phosphate based glass target may be any target as described herein.

By “high energy particle” beam, we mean a beam of accelerated particles with an energy capable of deducing the nuclear reaction in question typically for a proton energy above 1 MeV. Typically, therefore, the beam is provided by a particle accelerator, especially a cyclotron.

The high energy particle beam may be any suitable beam known in the art and can include a beam of nuclei, such as e.g. protons, deuterons, alpha-particles, ³He, carbon or lithium. Typically, the beam is a proton beam, a deuteron beam or a beam of alpha-particles.

Where the beam is a proton beam, the energy level of the proton beam is typically in the range 1 MeV to 100 MeV, preferably 5 MeV to 70 MeV. The proton beam intensity (also termed “beam current”) is preferably in the range 10 to 5000 μA, more preferably 50 to 500 μA.

Where the beam is a deuteron beam the energy level of the deuteron beam is typically in the range 1 MeV to 50 MeV, preferably 1 MeV to 35 MeV. The deuterium beam intensity (also termed “beam current”) is preferably in the range 10 to 1000 μA, more preferably 50 to 300 μA.

Where the beam is a beam of alpha-particles the energy level of the alpha beam is typically in the range 1 MeV to 100 MeV, preferably 5 MeV to 70 MeV. The alpha beam intensity (also termed “beam current”) is preferably in the range 10 to 1000 μA, more preferably 50 to 300 μA.

The radionuclides produced by the processes of the invention may have activity in the range 0.0001 to 10 TBq.

After irradiation of the phosphate based glass target, the radionuclide product is typically isolated from remaining target material and/or other side products, by selective precipitation, electrolysis, chromatographic methods, preferably by means of liquid chromatography, after dissolving the target material in a suitable solvent.

Time of irradiation is dependent of reaction cross section and the physical half-life of the product radionuclide, and is typically less than that corresponding to three times the half-life of the product radioisotope.

In one particular aspect, the invention provides a process as hereinbefore defined comprising:
providing a plate,
placing said target on the plate;
securing the target to the plate such that the target is fixed relative to the plate;
and irradiating the plate with target with a beam of high energy particles.

In another particular aspect, the invention provides a process as hereinbefore defined comprising:
providing a plate having a recessed portion,
placing said target in the recessed portion;
covering the target with a foil such that the target is encapsulated by the foil and the surface of the recessed portion,
securing the foil to the plate such that the target is fixed relative to the plate;
wherein the foil has a higher melting temperature than the target glass transition temperature; and
irradiating the encapsulated target with a beam of high energy particles.

The foil has a melting temperature above the glass transition temperature of the target. The foil may have an average thickness of from 5 μm to 5000 μm. The foil is typically a metal foil. When present, the metal in the foil may be inert towards molten target material, possessing a suitably high melting point, e.g. non-ferrous metal, niobium, tantalum, platinum, molybdenum, tungsten, vanadium, silver gold or an alloy.

The piece of target material may be a generally planar piece of the target material dimensioned to fit in the recessed portion, preferably wherein a thickness of the generally planar piece of target is between 0.1 mm and 30 mm and a largest dimension of the generally planar piece of target is between 0.2 cm and 10 cm.

The plate may be a plate comprising aluminium, non-ferrous metal, niobium, tantalum, platinum, molybdenum, tungsten, vanadium, silver, gold or an alloy.

The encapsulated target may be held fixed relative to the plate by a cover, the cover having an aperture. The aperture may be sized to be larger than a beam diameter of the high energy particle beam for irradiating the encapsulated target.

The plate may be cooled for some or all of the duration of the irradiation process. Cooling may take place by any suitable means, such as by using a constant flow of water, gas, CO₂ or liquid nitrogen or any cooling medium. Cooling of the target can preferably be performed from both sides of the target. In current designs of target stations from commercial vendors, the back of the target can be cooled with water and with He-gas in the front. Alternative approaches use water on both sides of the target or even targets immersed one of the liquids mentioned above.

This preferable embodiment is described in more detail below, with reference to FIGS. 3 to 9.

FIG. 3 shows a cover 10 having an aperture 12. The aperture is preferably located in the center of the cover 10. The cover 10 may be made of metal. Preferably, the metal has a high melting point and high heat transfer capacity, such as tantalum, aluminum, gold or copper. Aluminium is described in greater detail below due its low cost, suitable mechanical properties and short-lived activation products from irradiation with accelerated particles.

The cover 10 of FIG. 3 may be approximately square (i.e. length 24=length 22 in FIG. 3) and have an assembly hole 16 in each corner. These assembly holes 16 are for receiving fasteners 15, such as screws or pins, to hold the cover 10 to a plate 30 that is shown in FIG. 4.

The plate 30, as shown in FIG. 4, may be approximately square and have an assembly hole 36 in each corner for joining the cover 10 to the plate 30. The assembly holes 15 of the cover 10 should align with the assembly holes 36 on the plate 30 when the cover 10 is laid on top of the plate 30. The plate is preferably made of aluminum.

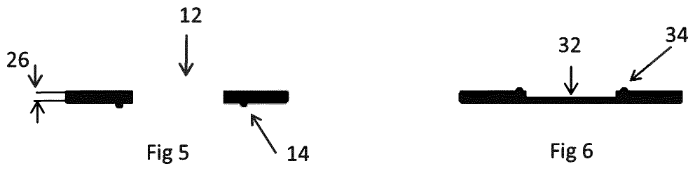

As shown in FIG. 6, the plate 30 may have a recessed portion 32 in the center such that a center of the recessed portion 32 is coaxial with a center of the aperture 12 of the cover 10 when the cover 10 is attached to the plate 30. In one embodiment, the recessed portion 32 is circular and the aperture 12 is circular. In this embodiment, the recessed portion 32 may have a larger diameter 38 than the diameter 18 of aperture 12. Alternatively, the diameter 38 of the recessed portion 32 may be equal to or smaller than the diameter 18 of the aperture 12. The recessed portion 32 does not extend through the entire thickness of the plate 30. That is, the recessed portion 32 may take the form of a blind hole in the plate 30.

Alternatively, the plate 30 and/or the recessed portion 32 may be made from other materials. It is envisaged that many materials are suitable. Further, the plate 30 and/or recessed portion 32 may be formed from metals that are inert in the presence of the target (at, at least, the melting temperature of the target) and the produced radionuclide. The recessed portion may be a surface of aluminum oxide.

A sealing ring 14, such as an O-ring, may be disposed in the cover 10. A sealing ring 34, such as an O-ring, may be disposed in the plate 30. Preferably, the two sealing rings 14, 34, are of equal size and are located so as to be coaxial when the cover is laid on top of the plate and fastened thereto. The sealing rings 14, 34 are to assist with gripping and sealing when the cover 10 is fastened to the plate 30.

The sealing rings 14, 34 may be rubber. Alternatively, the sealing rings 14, 34 may be any other material that is inert, heat-resistant (to the degree of the target temperature), and sufficiently compressible/sealable to prevent gas leakage when the sealing rings 14, 34 are compressed pressed when the cover 10 is fastened to the plate 30.

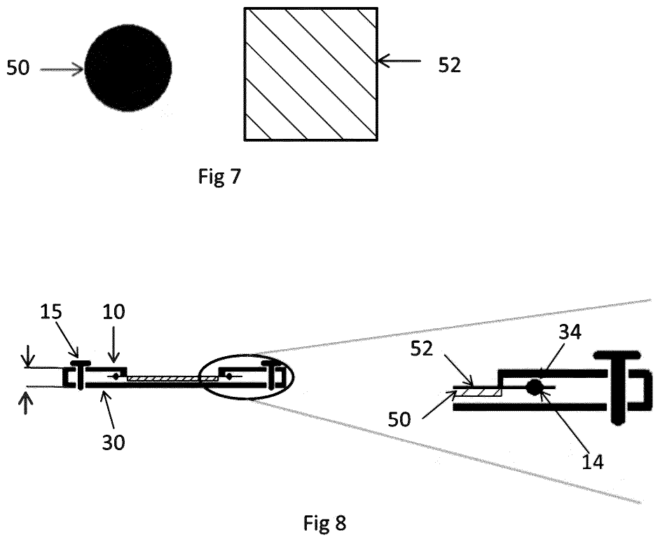

The target 50 may be placed in the recessed portion 32. As shown in FIG. 7, the target 50 may take the shape of a coin having a diameter less than or equal to the diameter 38 of the recessed portion 32. Other shapes are also envisaged for the target 50. Preferably the target 50 is shaped to match the shape of the recessed portion 32. The target material may be inserted as coin sized to fit in the recessed portion, or as multiple pieces, or in powdered form.

After the target 50 has been placed in the recessed portion 32 of the plate 30, a foil 52 may be laid on top of the target 50. The foil 52 may have a melting temperature above that of the target and is preferably made of a material that will not react with the target 50. Preferably, the foil will not interact, or only interact minimally, with the beam of protons. For example, the foil 52 may be platina foil. Other suitable materials may be used for the foil 52, for example, a foil of, niobium, tantalum, platinum, molybdenum, tungsten, vanadium, silver gold or an alloy thereof may be suitable. Further, different thicknesses of foil may be used. The foil will reduce the energy of the incoming particle beam. Thus, one criterion governing the choice of foil material and thickness is based on the energy of the particle beam. Preferably, the foil material will have a combination of low stopping power as well as being chemically inert and physically stable in the presence of heated target material.

The foil 52 may be dimensioned such that it may be overlaid on the sealing rings 14, 34 of the plate 30 and touch the sealing rings at every point. That is, the foil 52 may be larger than the sealing ring border. For example, the foil shown in FIG. 7 is square and has a side-length greater than diameter 20 of the sealing rings 14, 34 shown in FIGS. 3-6. Preferably, the sealing rings are sufficiently compressible such that, when the cover 10 is fastened to the plate 30, the foil 52 is contacted and held by both the cover 10 and the plate 30.

Alternatively, the foil 52 may be provided integrally with the cover 10. In this embodiment, the aperture 12 consists of a thin portion of the cover, either made from the same material as the cover 10 or from a separate material joined to the cover. This thin portion of the cover 10 is thin so as to limit the energy loss of radiation passing through the aperture, so that radiation may interact with the target nuclide held in the recessed portion, beneath the thin portion that is the aperture 12 of the cover 10.

During assembly, the target 50 may be placed in the recessed portion 32. The foil 52 may then be laid on top of the target 50. The cover 10 may then be placed on top of the plate 30 and the foil 52, such that the sealing ring 14 of the cover 10 presses the foil 52 into the sealing ring 34 of the plate 30. The cover 10 may then be fastened to the plate 30.

Pressure from the cover 10 onto the foil 52, and from the foil 52 onto the target 50 may hold the target 50 in place within the recessed portion 32 of the plate 30. The entire assembly may then be spatially oriented and the target 50 will stay in place within the recess. That is, the target is encapsulated in a region defined by the foil and the recessed portion. If the target 50 extends above the depth of the recessed portion 32, then a portion of the plate between the recessed portion 32 and the sealing ring 34 may also form part of the encapsulating region. For example, the plate 30 may be oriented vertically such that the normal line from the base of the recessed portion 32 points horizontally. Alternatively, the plate 30 may be laid flat such that the normal line from the base of the recessed portion 32 points vertically up or down. That is, the target may be used in any spatial orientation which may increase the number of suitable cyclotrons the target may be used with.

The above-described apparatus may be presented as a target at the output of a cyclotron or other particle accelerator. Hereafter, the disclosure will refer to cyclotrons, but it is to be understood that the invention is not so limited and other particle accelerators may be used as appropriate.

The foil 52, may have a much higher melting temperature than the target. The foil 52 may also prevent any release of radionuclide to the atmosphere. This may be a useful safety feature inherent to this design.

After irradiation by protons, the apparatus may be removed from the cyclotron. The foil 52 is preferably selected to be inert with respect to the target. Further, the foil is preferably selected to be physically stable under the expected heating of the target material during irradiation. For example, the foil may have a melting temperature higher than, preferably much higher than, the melting temperature of the target. In this case, if melted and resolidified, the irradiated material may be easily separated from both the recessed portion 32 and foil 52.

By way of non-limiting example, the plate 30 and cover 10 may each be 40×40 mm and the aperture 12 of the cover 10 may have a diameter 18 of 10-20 mm, preferably 17 mm. The recessed portion may have a diameter 38 of 20-22 mm and 1.3 mm in depth. The piece of target material 50 may be a cylinder having a diameter of 17 mm and a thickness of 1.68 mm. The foil 52 may be 25×25 mm and 0.01 mm thick. Thus, when the piece of target material 50 is placed in the recessed portion 32, it extends above the rim of the recess by 0.38 mm and the foil 52 thickness adds an extra 0.01 mm. When the cover 10 is fastened to the plate 30, the target material 50 is firmly held in the recessed portion 32 by pressure from the cover 10 holding the foil 52 against the plate 30.

The invention will now be described with reference to the following non limiting examples and figures.

FIG. 1: Structural units of phosphate glass materials

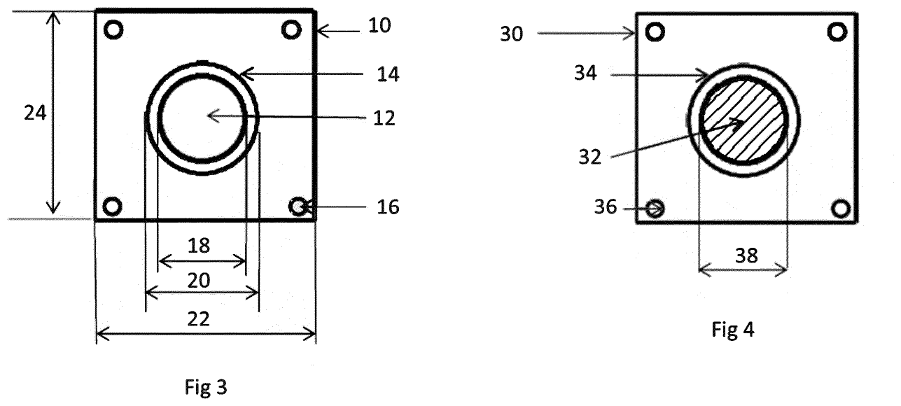

FIG. 2: Platinum crucible with a melt of phosphate and enriched isotope positions in the outer area of a furnace. A mould of steel is placed outside. Also shown is a flat metal spatula that is used to flatten the liquid material after it has been poured into the mould.

FIG. 3: Plan view of a cover having an aperture in one embodiment of the invention

FIG. 4: Plan view of a plate having a recessed portion in one embodiment of the invention

FIG. 5: Side view of the cover of FIG. 3

FIG. 6: Side view of the plate of FIG. 4

FIG. 7: Piece of target material and a piece of foil

FIG. 8: Side view and enlarged side view of the apparatus formed from the cover, plate, target nuclide, and foil in one embodiment of the invention

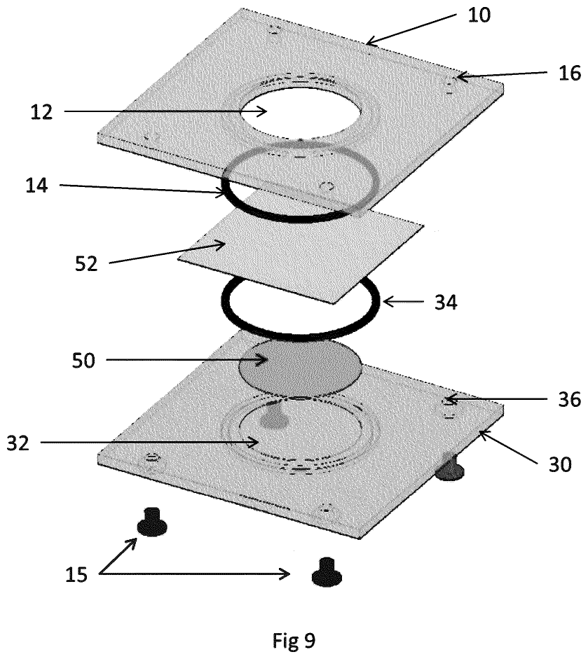

FIG. 9: Exploded view of the apparatus formed from the cover, sealing rings, plate, foil, and target nuclide in one embodiment of the invention

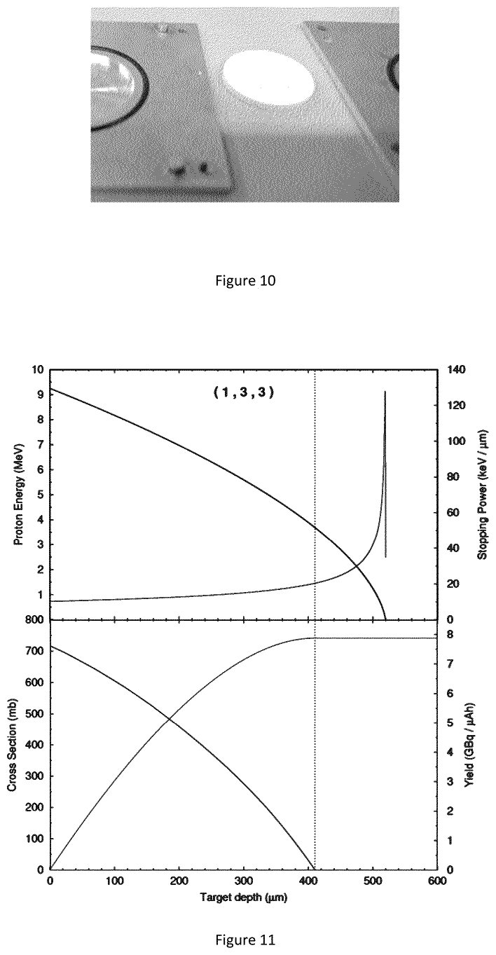

FIG. 10: The ceramic zinc target (mid) is shown between the bottom (left) and top (right) of the target holder

FIG. 11: The upper part of the graph shows the energy reduction of protons inside material #2 as function of depth, and the linear energy transfer during the traverse. The lower part shows the reaction cross-section (reflecting probability) of the reaction of interest as function of energy at increasing target depth. The production rate reaches maximum and flattens at optimal target thickness.

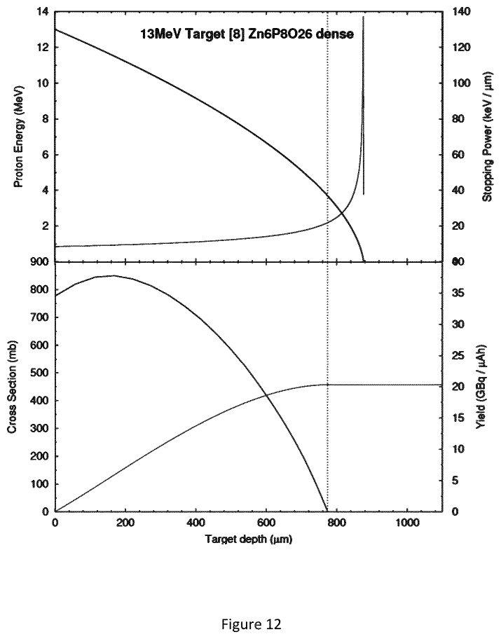

FIG. 12: As FIG. 11, but for higher proton energy (13 MeV).

### EXAMPLES

### Preparation of Glass Material #1 with Zinc

To a 10 ml platinum crucible was added 2.0 g Zn₃(PO₄)₂, 1.47 g P₂O₅ and 0.85 g ZnO. The mixture was homogenized before it was placed in a preheated furnace at 330° C. The temperature was increased to 350° C. over a period of 10 minutes. After this, the temperature was set to reach 1100° C. within 20 min. After holding the temperature at 1100° C. for 30 minutes, the crucible was manipulated and extracted from the furnace by a tong, and the melt was quickly poured into the mold and, essentially simultaneously, the material was flattened into a disc with a spatula. The resulting molded glass disc was subjected to an annealing process, in order to free the material from built in tensions caused by the cold quenching, by heating in a furnace for 15 minutes at 515° C. Finally, the resulting discs were placed in a holder and grained down to the desired thickness, e.g. 400 μm.

For the manufacturing of isotope enriched target discs with Zn₃(PO₄) as a part of the formulation, the [⁶⁸Zn]Zn₃(PO₄)₂ is prepared by the reaction of [⁶⁸Zn]ZnO with dilute phosphoric acid prior to drying the precipitate, followed by graining the material to yield a powder in a mortar. Also the zinc oxide part in the making of glass is substituted by [⁶⁸Zn]ZnO.

Different compositions of zinc phosphate glass were investigated, with and without Zn₃(PO₄)₂ and with variable molar ratios of P₂O₅ and ZnO (Table 1).

TABLE 1
Composition of selected phosphate based glass materials, displaying
the weight percentage of zinc and the density of the materials.

| | Zn₃(PO₄)₂ | P₂O₅ | ZnO | Zn | |
|---|---|---|---|---|---|
| | (Molar | (Molar | (Molar | Weight | Density |
| Material # | ratio) | ratio) | ratio) | (%) | (g/cm₃) |
| 1 | 1 | 2 | 2 | 39 | |
| 2 | 1 | 3 | 3 | 37 | 2.9 |
| 3 | 1 | 4 | 4 | 36 | 3.0 |
| 4 | 1 | 5 | 5 | 35 | 3.1 |
| 7 | 0 | 1 | 1.25 | 33 | 2.9 |
| 8 | 0 | 1 | 1.5 | 37 | 3.1 |

Heating tests with discs of the different materials (from Table 1) were performed in a furnace with slow increase of temperatures. In the range of the transition temperature, 600-700° C., the material underwent a metamorphic process leading to crystallization. Upon increased temperatures, 800-1100° C., the materials reformed as glass. Upon cold quenching of this discs could be molded.

To provide target disc materials for production of gallium with the GE cyclotron, MINITrace (accelerating protons up to 9.6 MeV), we molded discs with a diameter of 12 mm that were fitted into a target holder.

The required target disc thickness was chosen based on the following: i) to capture the part of energy interval from Eₚᵣₒₜₒₙ 9.6. MeV down to the threshold for the nuclear reaction (Eₚᵣₒₜₒₙ<4 MeV), ensuring maximum product yield whilst ii) avoiding deposition (in the target) of the peak-value of energy transfer per unit length of the proton (termed avoiding capture of the “Bragg peak”; see red line in FIG. 11). The thickness of targets was determined from calculations based on the zinc content and density of each of the materials that were subjected to testing. The upper part of FIG. 11 shows the energy reduction of protons inside material #2 as function of depth, and the linear energy transfer during the traverse. The lower part shows the reaction cross-section (reflecting probability) of the reaction of interest as function of energy at increasing target depth. The production rate reaches maximum and flattens at optimal target thickness. Here, the molded discs of material #2 was grained and polished to a thickness of about 400 μm (optimal thickness seen from graph below) by use of a grinding and sanding machine.

The calculations from FIG. 11 are specific for material #2, with 9.6 MeV protons and taking into account the cross section nuclear data for the reaction ⁶⁸Zn(p,n)⁶⁸ Ga. In preparation for runs with a more powerful cyclotron, e.g. GE PETtrace, E_{proton, max}=16.5 MeV, the same calculations, as above, for the same material have been performed for proton energies first moderated from 16.5 MeV to Eₚᵣₒₜₒₙ=13 MeV (FIG. 12) and revealed an optimal thickness around 800 μm with a potential for a doubling of the production rate (GBq/μAh) relative to our hitherto obtained data.

1. A phosphate based glass target material, wherein said material comprises an isotopically enriched element or monoisotopic element.

2. The phosphate based glass target material as claimed in claim 1, wherein the isotopically enriched element or monoisotopic element is selected from the group consisting of metals, metalloids and non-metals.

3. The phosphate based glass target material as claimed in claim 1, wherein the isotopically enriched element or monoisotopic element is selected from the group consisting of Mo, Ra, Y, Ca, Ni, Zn, Ga, 0, Rb, Se, Te, Bi, Th and Yb.

4. The phosphate based glass target material as claimed in claim 1, wherein the isotope is selected from the group consisting of ¹⁰⁰Mo, ²²⁶Ra, ⁸⁹Y, ⁴⁴Ca, ⁶⁴Ni, ⁷⁰Zn, ⁶⁷Zn, ⁶⁸Zn, ⁶⁹Ga, ¹⁸O, ⁸⁵Rb, ⁷⁶Se, ⁷⁷Se, ¹²⁴Te, ²⁰⁹Bi and ¹⁷⁶Yb.

5. The phosphate based glass target material as claimed in claim 1, wherein said phosphate based material glass has a glass transition temperature in the range 200° C. to 2000° C.

6. The phosphate based glass target material as claimed in claim 1, wherein the phosphate based target has a density in the range 2 to 10 g/cm³.

7. The phosphate based glass target material as claimed in claim 1, wherein the isotopically enriched element or monoisotopic element is present in an amount of 10 to 50 wt %, relative to the total weight of the material as a whole.

8. A process for preparing the phosphate based glass material of claim 1, said process comprising:
i. mixing a metal, metalloid or non-metal oxide with dilute phosphorous acid (H₃PO₄) to form a phosphate compound; and
ii. Melting said phosphate compound with phosphorous pentoxide and/or or an oxide of the isotope enriched element to produce the phosphate based glass material.

9. A process for the production of a radionuclide, comprising irradiating a phosphate based glass target material with a high energy particle beam.

10. The process as claimed in claim 9, wherein said phosphate based glass target comprises an isotopically enriched element or monoisotopic element.

11. The process as claimed in claim 9, wherein the high energy particle beam is provided by a particle accelerator.

12. The process as claimed in claim 9, wherein the high energy particle beam is a proton beam, deuteron beam or a beam of alpha-particles.

13. The process as claimed in claim 9, comprising the steps:
providing a plate having a recessed portion, the recessed portion having a surface;
placing said phosphate based glass target material in the recessed portion;
covering the phosphate based glass target material with a foil such that the phosphate based glass target material is encapsulated by the foil and the surface of the recessed portion;
securing the foil to the plate such that the phosphate based glass target material is fixed relative to the plate;
wherein the foil has a higher melting temperature than the phosphate based glass target material glass transition temperature; and
irradiating the encapsulated phosphate based glass target material with a beam of high energy particles.

14. A method of use of a phosphate based glass target in a process for producing radionuclides.

15. The method of claim 14, wherein the phosphate based glass material is used as a target in a process for producing radionuclides.

16. The method of claim 14, wherein said phosphate based glass target comprises an isotopically enriched element or monoisotopic element.

17. The phosphate based glass target material of claim 1, wherein the isotopically enriched element or monoisotopic element is selected from the group consisting of Zn, Y, and Mo.

18. The phosphate based glass target material of claim 1, wherein the isotope is selected from the group consisting of ⁶⁸Zn, ⁸⁹Y and ¹⁰⁰Mo.

19. The process of claim 9, wherein the high energy particle beam is provided by a cyclotron.
